(19) United States
(12) Patent Application Publication
(10) Pub. No.: US 2018/0129982 A1
(43) Pub. Date: May 10, 2018

(54) SEAT PRESENTATION SYSTEM AND SEAT PRESENTATION METHOD

(71) Applicant: Panasonic Intellectual Property Management Co., Ltd., Osaka (JP)

(72) Inventors: NAOMI TOMIYAMA, Kyoto (JP); YASUKO IKETSUKI, Tokyo (JP); ATSUSHI SASO, Kanagawa (JP); TAKAMICHI MATSUSAKO, Tokyo (JP); YUICHI AOKI, Osaka (JP); MOTOJI OHMORI, Osaka (JP); AKIRA ASAI, Osaka (JP)

(21) Appl. No.: 15/796,670

(22) Filed: Oct. 27, 2017

(30) Foreign Application Priority Data
Nov. 10, 2016 (JP) 2016-219741

(51) Int. Cl. G06Q 10/02; G06Q 10/04

(52) U.S. Cl. CPC G06Q 10/02; G06Q 10/04

(57) ABSTRACT

A seat presentation system, including: an accumulator accumulating biological history data in which first biological data of a customer measured during boarding, a seat identifier indicating a seat of the on-board customer, and a customer identifier identifying the customer are associated with each other; a preference data generator generating, based on the biological history data of the customer, preference data in which a position attribute indicating an attribute of a seat position of the customer and a first stress indicator calculated based on the first biological data are associated with each other; a priority calculator calculating a second stress indicator which corresponds to each of seat regions specified by the position attribute by using the preference data, and calculates priorities among the seat regions based on the second stress indicator; and a presentation processor presenting the reservation candidate seats from a seat belonging to the higher priority seat region.

### BACKGROUND

### 1. Technical Field

The present disclosure relates to a technique for presenting a seat to be a reservation candidate to a customer of transportation such as an airplane.

### 2. Description of the Related Art

In recent years, various techniques have been suggested which use vital data of a person to estimate stress to the person. Accordingly, studies of techniques for providing various services for users by using the technique have been progressing. Japanese Unexamined Patent Application Publication No. 2016-101307 discloses a technique for assessing stress to a target person from biological information of the target person who sits on a seat of an airplane.

### SUMMARY

One non-limiting and exemplary embodiment provides a technique for presenting a reservation candidate seat in consideration of preference of a customer about a seat position.

In one general aspect, the techniques disclosed here feature a seat presentation system, including: an accumulator that accumulates biological history data in which first biological data of a customer, a seat identifier, and a customer identifier are associated with each other, the first biological data being measured while the customer is on board, the seat identifier indicating a seat of the customer on board, the customer identifier identifying the customer; a preference data generator that generates, based on the biological history data of the customer, preference data in which a position attribute and a first stress indicator are associated with each other, the position attribute indicating an attribute of a position of the seat of the customer, the first stress indicator being calculated based on the first biological data; a priority calculator that calculates second stress indicator which corresponds to each of seat regions specified by the position attribute by using the preference data, and calculates priorities among the seat regions based on the second stress indicator; and a presentation processor that presents seats to be reservation candidates sequentially from a seat which belongs to the seat region with higher priority.

It should be noted that general or specific embodiments may be implemented as an element, a device, an apparatus, a system, an integrated circuit, a method, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a diagram that illustrates one example of a general configuration of a seat presentation system according to a first embodiment of the present disclosure;

FIG. 2 is a block diagram that illustrates a configuration of the seat presentation system according to the first embodiment of the present disclosure;

FIG. 3 is a diagram that illustrates one example of a data configuration of a saved biological table that is stored in a storage unit;

FIG. 4 is a diagram that illustrates one example of a data configuration of a reservation information table;

FIG. 5 is a diagram that illustrates one example of a data configuration of a biological history table;

FIG. 6 is a diagram that illustrates one example of a seat arrangement diagram which illustrates arrangement of seats in a cabin of an airplane;

FIG. 7 is a diagram that illustrates one example of a data configuration of a preference data table in which preference data are registered;

FIG. 8 is a flowchart that illustrates one example of a process from measurement of biological data to generation of the preference data in the seat presentation system according to the first embodiment of the present disclosure;

FIG. 9 is a flowchart that illustrates details of an analysis process of the biological history data which is illustrated in FIG. 8;

FIG. 10 is a flowchart that illustrates a process in a case where a reservation by a customer is received in the seat presentation system according to the first embodiment of the present disclosure;

FIG. 11 is a diagram that illustrates one example of a general configuration of a seat presentation system according to a second embodiment of the present disclosure;

FIG. 12 is a block diagram that illustrates a configuration of the seat presentation system according to the second embodiment of the present disclosure;

FIG. 13 is a diagram that illustrates one example of a data configuration of a first saved biological table in which first saved biological data are registered in the second embodiment of the present disclosure;

FIG. 14 is a diagram that illustrates one example of a data configuration of second saved biological data according to the second embodiment of the present disclosure;

FIG. 15 is a diagram that illustrates one example of a data configuration of a biological history table in which the biological history data are registered according to the second embodiment of the present disclosure;

FIG. 16 is a flowchart that illustrates one example of a process from measurement of first and second biological data to generation of the preference data in the seat presentation system according to the second embodiment of the present disclosure; and

FIG. 17 is a flowchart that illustrates details of an analysis process of the biological history data which is illustrated in FIG. 16.

### DETAILED DESCRIPTION

### (Underlying Knowledge Forming Basis of the Present Disclosure)

Above Japanese Unexamined Patent Application Publication No. 2016-101307 discloses a technique of detecting biological information of a target person who sits on a seat by a pressure sensing tube provided to the seat of an airplane, assessing stress of the target person from the detected biological information, and performing a notification to a flight attendant, a pilot, or the like in a case where the assessed stress is high.

However, a fundamental purpose of Japanese Unexamined Patent Application Publication No. 2016-101307 is to provide a biological information acquisition apparatus that may improve detection accuracy of the biological information of the target person (paragraph [0008]). Japanese Unexamined Patent Application Publication No. 2016-101307 only discloses a specific example in which the biological information acquisition apparatus is arranged in a seat portion of an airplane, as one aspect. Further, Japanese Unexamined Patent Application Publication No. 2016-101307 only discloses that a flight attendant or a pilot provides a service with full attention for a target person with high stress, as an effect of the specific example.

Therefore, Japanese Unexamined Patent Application Publication No. 2016-101307 does not take into consideration reflection of the stress to the target person to a seat reservation at all. Thus, Japanese Unexamined Patent Application Publication No. 2016-101307 has a problem in that a preferred seat may not be presented to a customer of an airplane as a reservation candidate.

Further, in Japanese Unexamined Patent Application Publication No. 2016-101307, measurement of the biological information is performed simply for assessing the magnitude of stress, and accumulation of the biological information is not performed. Thus, in Japanese Unexamined Patent Application Publication No. 2016-101307, it is not possible to understand a preferred seat by the customer of the airplane by using the accumulated biological information, and the above problem may thus not be solved.

In such a manner, Japanese Unexamined Patent Application Publication No. 2016-101307 only discloses that in a case where the target person with high stress is present, that effect is notified to a flight attendant or the like. However, the preference of the target person for the seat of the airplane is not assessed. Thus, in Japanese Unexamined Patent Application Publication No. 2016-101307, the seat to be the reservation candidate may not be suggested based on the preference of the customer for a seat position.

It is desirable to provide a technique for presenting a preferred seat as a reservation candidate to a customer of transportation such as an airplane.

A seat presentation system according to one aspect of the present disclosure is a seat presentation system, including:

an accumulator that accumulates biological history data in which first biological data of a customer, a seat identifier, and a customer identifier are associated with each other, the first biological data being measured while the customer is on board, the seat identifier indicating a seat of the customer on board, the customer identifier identifying the customer;

a preference data generator that generates, based on the biological history data of the customer, preference data in which a position attribute and a first stress indicator are associated with each other, the position attribute indicating an attribute of a position of the seat of the customer, the first stress indicator being calculated based on the first biological data;

a priority calculator that calculates second stress indicator which corresponds to each of seat regions specified by the position attribute by using the preference data, and calculates priorities among the seat regions based on the second stress indicator; and

a presentation processor that presents seats to be reservation candidates sequentially from a seat which belongs to the seat region with higher priority.

In the above aspect, the seat presentation system may further include a first biological sensor that measures the first biological data of the customer on board.

In this aspect, the biological history data in which the first biological data of the customer on board an airplane, the seat identifier which indicates the seat on which the customer sits on board, and the customer identifier which identifies the customer are associated with each other are accumulated. Further, the preference data, which indicates the stress indicator of the customer in accordance with the position attribute to which the seat on which the customer sits on board belongs from the accumulated biological history data, are generated. Accordingly, the seat that is preferred by the customer may be learned from the biological history data. Further, the plural seat regions are ranked such that the seat regions in which the customer is more comfortable have the higher priority based on the preference data, and the seat to be the reservation candidate is sequentially presented from the seat included in the seat region with the higher priority. Thus, the seat preferred by the customer may be presented as the reservation candidate, and a smooth seat reservation may be realized.

In the above aspect, the position attribute may include a first position attribute and a second position attribute, the first position attribute indicating each of seat regions which are obtained by dividing a cabin of a transportation in a longitudinal direction, the second position attribute indicating each of seat regions which are obtained by dividing the cabin in a transverse direction,

the preference data generator generates, as the preference data, first preference data that correspond to the first position attribute and second preference data that correspond to the second position attribute, and

the priority calculator calculates the second stress indicator which corresponds to each of seat regions specified by a pair of the first position attribute and the second position attribute by using the first preference data and the second preference data, and calculates the priorities based on the second stress indicator.

In this aspect, the cabin of the airplane is divided into plural regions such as front and rear regions in the longitudinal direction (the traveling direction of the airplane), for example, and the first preference data that indicate the stress indicators for plural first position attributes are generated. Further, the cabin of the airplane is divided into plural regions such as left and right regions in the horizontal transverse direction (a direction that is orthogonal to the longitudinal direction), for example, and the second preference data that indicate the stress indicators for plural second position attributes are generated.

Further, the stress indicator for the first position attribute and the stress indicator for the second position attribute are used, and the stress indicators are thereby calculated for the plural seat regions which are specified by the pairs of the first position attribute and the second position attribute. For example, the stress indicators are calculated for the front and left seat region, the front and right seat region, the rear and left seat region, and the rear and right seat regions. Then, the priority of each of the seat regions is decided in order from lowest to highest stress indicator.

Thus, the preference of the customer for the seat may be assessed carefully.

In the above aspect, the position attribute may include a third position attribute that indicates a seat region around a door of the transportation,

the preference data generator generates, as the preference data, third preference data that correspond to the third position attribute, and

the priority calculator calculates the second stress indicator which corresponds to each of the seat regions specified by a group of the first position attribute, the second position attribute, and the third position attribute by using the first preference data, the second preference data, and the third preference data, and calculates the priorities based on the second stress indicator.

In this aspect, because the priority of the seat region is decided in consideration of the stress indicator for the seat region around a boarding door, the preference of the customer for the seat may be assessed more carefully.

In the above aspect, the seat presentation system may further include a second biological sensor that measures second biological data of the customer at a time before boarding, wherein

the accumulator accumulates the second biological data of the customer associated with the first biological data of the customer as the biological history data, and

the preference data generator calculates the first stress indicator based on the first biological data and the second biological data.

In this aspect, the stress indicator is calculated based on the difference between a second stress value calculated from the second biological data at a time before the customer boards the airplane, for example, at a time when the customer passes through a boarding gate and the first stress value calculated from the first biological data of the customer who has boarded the airplane. Thus, the stress indicator of each of the customers may accurately be calculated.

In the above aspect, the presentation processor may present the seat to be the reservation candidate to a terminal apparatus that is possessed by the customer.

In this aspect, because the seat to be the reservation candidate may be presented to the terminal apparatus possessed by the customer, the customer uses the terminal apparatus possessed by him/her and may thereby recognize the preference of himself/herself for the seat.

In the above aspect, the presentation processor may present the seat to be the reservation candidate to a terminal apparatus installed in a check-in counter.

In this aspect, because the seat to be the reservation candidate is presented to the terminal apparatus that is installed in the check-in counter, for example, the customer may reserve the seat that matches his/her preference at the check-in counter.

In the above aspect, the preference data generator may update the preference data in a case where the accumulator accumulates the biological history data of the customer anew.

In this aspect, because the preference data are generated at each time when the new biological history data are accumulated, the preference data that accurately reflect the preference of a user may be generated.

### First Embodiment

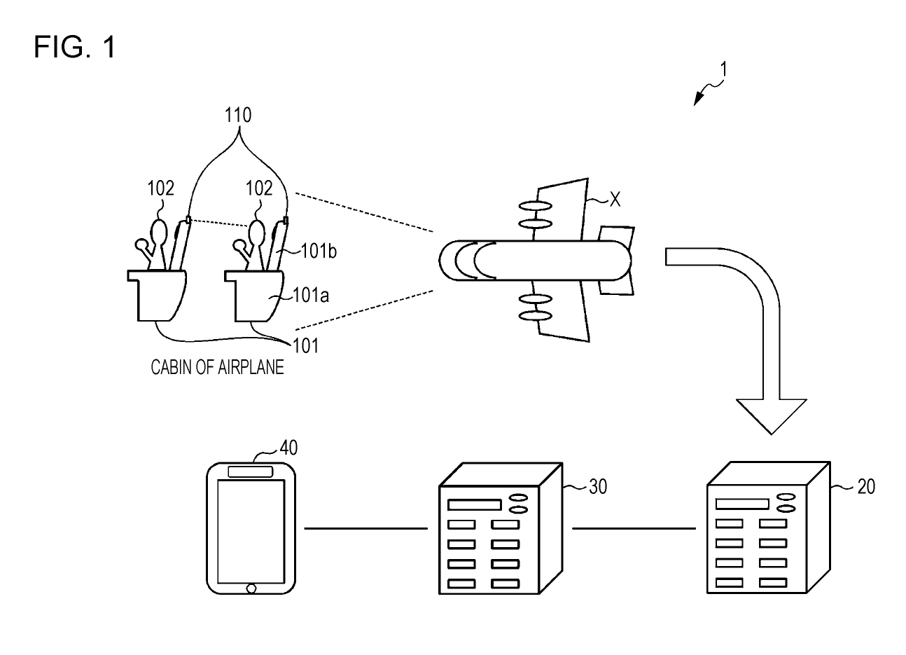

FIG. 1 is a diagram that illustrates one example of a general configuration of a seat presentation system 1 according to a first embodiment of the present disclosure. The seat presentation system 1 includes plural biological sensors 110 that are mounted on plural seats 101 of an airplane X, a stress learning apparatus 20 that learns stress to a customer 102 from biological data which are measured by the biological sensor 110, a reservation management apparatus 30 that manages a reservation situation of the airplane X, and a reservation terminal 40 that is used in a case where the customer 102 makes a reservation for the airplane X.

The airplane X is a passenger plane that is owned by an airline company, for example. The airplane X includes the plural seats 101 on which plural customers 102 sit. The plural biological sensors 110 are respectively provided to the plural seats 101. However, this is one example, and in a case where the biological sensor 110 is configured with a biological sensor that is capable of simultaneously measuring biological data of plural persons, one biological sensor 110 may be provided for plural seats that correspond to plural persons whose biological data are measurable.

The seat 101 includes a seat portion 101a that supports a lower back of the customer 102 and a back portion 101b that supports a back of the customer 102. The biological sensor 110 is configured with a millimeter-wave radar, for example, and is arranged to be opposed to the customer 102 who sits on the rear seat 101 in the back portion 101b. In the example of FIG. 1, the biological sensor 110 is arranged at an upper end of the back portion 101b. However, this is one example, and the biological sensor 110 may be arranged at the back portion 101b to be positioned in front of a face of the customer 102. The directivity of the biological sensor 110 is set such that a millimeter wave (measurement wave) radiated to the customer is radiated to the vicinity of the face of the sitting customer 102.

Further, in the example of FIG. 1, the biological sensor 110 is provided to the back portion 101b. However, this is one example, and the biological sensor 110 may be provided to a ceiling in a cabin of the airplane X. In this case, the biological sensor 110 may be provided to a ceiling to be positioned directly above each of the seats 101.

The stress learning apparatus 20 is configured with a computer that includes a CPU, a ROM, a RAM, a communication apparatus, and so forth, for example, and is connected with the airplane X via a prescribed network so as to be capable of communication. The reservation management apparatus 30 is configured with a computer that includes a CPU, a ROM, a RAM, a communication apparatus, and so forth, for example, and is connected with the stress learning apparatus 20 via a prescribed network so as to be capable of communication. The reservation terminal 40 is configured with a portable computer such as a smartphone, a tablet terminal, or a feature phone with buttons, for example, which is possessed by the customer 102, and is connected with the reservation management apparatus 30 via a prescribed network so as to be capable of communication. The reservation terminal 40 is used in a case where the customer 102 makes a reservation for a seat of the airplane X, for example. A description is made that the reservation terminal 40 is configured with the portable computer. However, this is one example, and the reservation terminal 40 may be configured with a stationary computer that is installed in a home of the customer 102, for example.

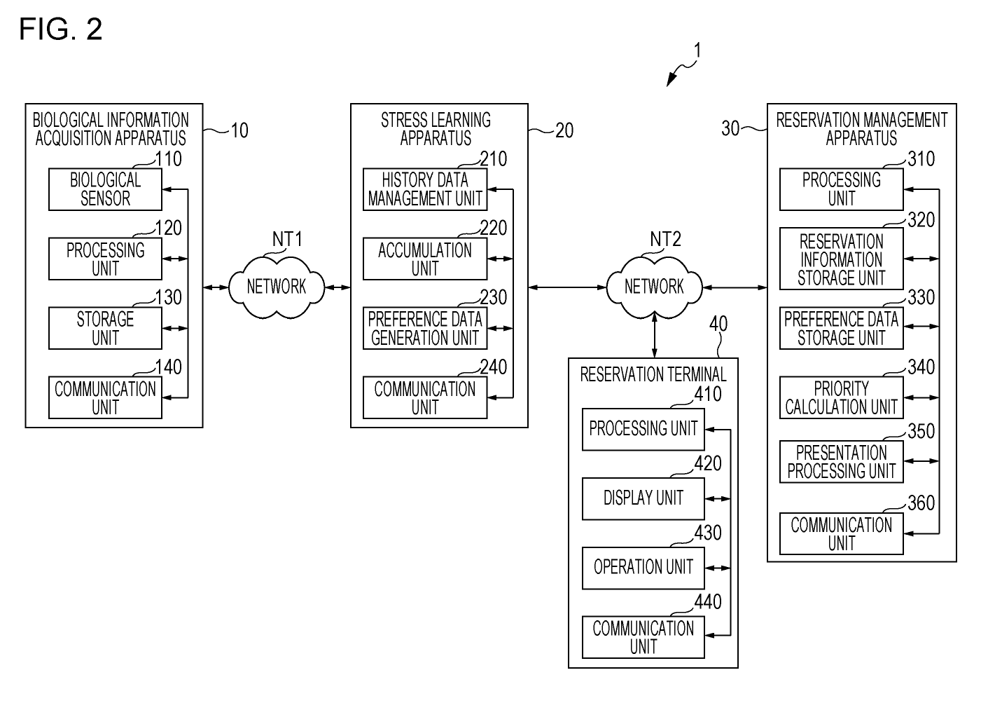

FIG. 2 is a block diagram that illustrates a configuration of the seat presentation system 1 according to the first embodiment of the present disclosure. The seat presentation system 1 includes a biological information acquisition apparatus 10 that is provided to the airplane X and the stress learning apparatus 20, the reservation management apparatus 30, and the reservation terminal 40 which are illustrated in FIG. 1. The biological information acquisition apparatus 10 and the stress learning apparatus 20 are connected via a network NT1 so as to be capable of mutual communication. As the network NT1, a public telecommunication network may be employed which includes a radio communication network such as Wi-Fi® which is capable of communication between an airplane and a base station on the ground.

The stress learning apparatus 20, the reservation management apparatus 30, and the reservation terminal 40 are connected via a network NT2 so as to be capable of mutual communication. As the network NT2, a public telecommunication network may be employed which includes a cellular phone communication network, a Wi-Fi® communication network, an Internet communication network, and so forth. Note that for convenience of description, FIG. 2 separately illustrates the network NT1 and the network NT2. However, this is one example, and both of the networks may be the same.

The biological information acquisition apparatus 10 is configured with a computer that is provided in the airplane X, for example, and includes the biological sensor 110 (one example of a first biological sensor), a processing unit 120, a storage unit 130, and a communication unit 140.

The biological sensor 110 is connected with the communication unit 140 so as to be capable of communication by a wireless LAN or a wired LAN, measures biological information of the customer 102 who sits on the seat 101, and transmits the biological information to the communication unit 140. In recent years, a measurement technique has been known which simultaneously and contactlessly measures the biological data of plural persons by using a millimeter-wave radar. Specifically, this measurement technique radiates a millimeter wave of 60 GHz band to a person, for example, extracts a heartbeat signal from a measured radar signal, extracts phase characteristic points from the extracted heartbeat signal, and estimates heartbeat intervals from a time-series pattern of the extracted phase characteristic points.

Then, in a case where the heartbeat intervals may be estimated, a frequency analysis of the fluctuation of the heartbeat intervals is performed as disclosed in Japanese Patent No. 5257525, for example, and the stress to a person may thereby be detected.

Accordingly, in this embodiment, the millimeter-wave radar is employed as the biological sensor 110.

Further, Japanese Unexamined Patent Application Publication No. 2016-101307, which is described in description of the related art, discloses a technique for measuring the biological information of a target person based on a pressure sensing tube attached to the seat portion 101a and the signal that corresponds to an internal pressure which occurs in the pressure sensing tube. Accordingly, in the present disclosure, the biological information of the customer 102 may be measured by using the technique disclosed in Japanese Unexamined Patent Application Publication No. 2016-101307.

The processing unit 120 is configured with a CPU, for example, and conducts general control of the biological information acquisition apparatus 10. The processing unit 120 generates saved biological data by associating the biological data measured by the biological sensor 110 with a seat identifier and with a flight number identifier of the airplane X and stores the saved biological data in the storage unit 130. The storage unit 130 is configured with a non-volatile storage apparatus, for example, and stores a saved biological table T1 in which the saved biological data are registered.

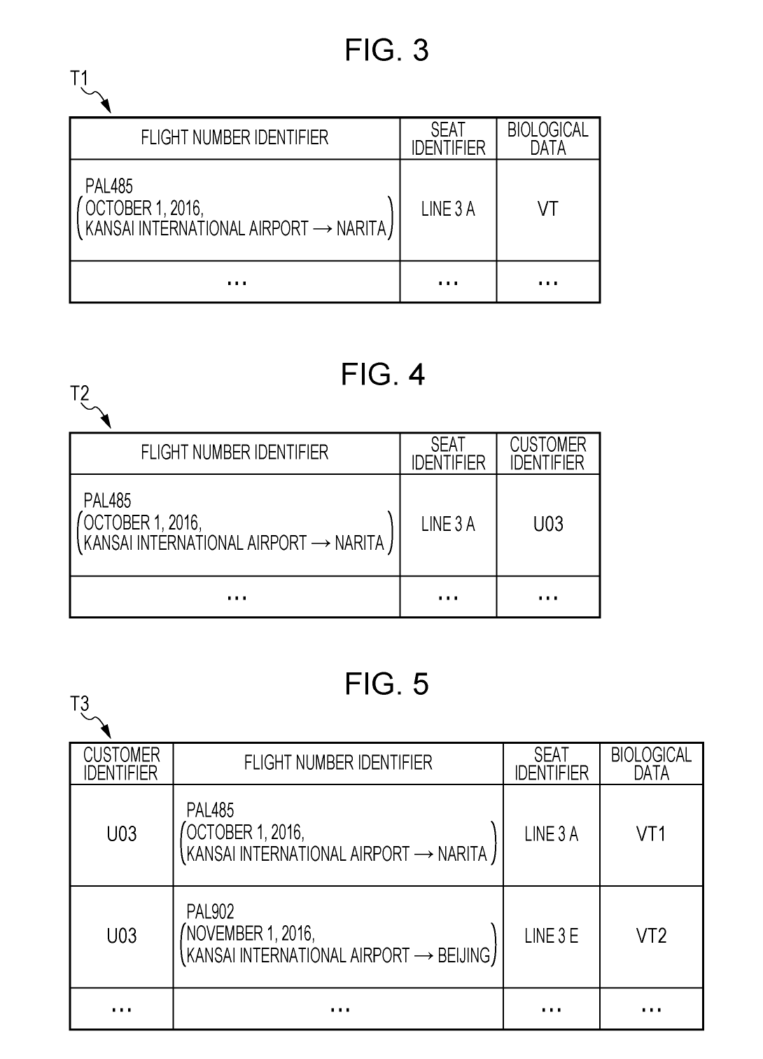

FIG. 3 is a diagram that illustrates one example of a data configuration of the saved biological table T1 that is stored in the storage unit 130. The saved biological table T1 is a table in which one piece of saved biological data is registered in one record and includes fields of “flight number identifier”, “seat identifier”, and “biological data”.

“Flight number identifier” is an identifier of the airplane X and includes a flight number, a flight date, and a flight route. In the example of FIG. 3, the flight number identifier that is configured with the flight number of “PAL485”, the flight date of “Oct. 1, 2016”, and the flight route of “Kansai International Airport to Narita Airport” is registered.

“Seat identifier” is information that identifies each of plural seats in the cabin of the airplane X and employs a symbol string that is uniquely allocated to each of the seats. In the field of “biological data”, the biological data measured by the biological sensor 110 are registered.

Here, because the biological sensor 110 measures the biological data at regular sampling intervals while the airplane X is flying, the biological data become time-series data of measurement values of the biological data by the biological sensor 110. The biological sensor 110 transmits the biological data that are associated with the seat identifier which is in advance allocated to the biological sensor 110. Thus, the processing unit 120 may generate the saved biological data while associating the seat identifier with the biological data. Note that as the seat identifier allocated to the biological sensor 110, as illustrated in FIG. 1, the seat identifier of the seat 101 on which the customer 102 to be a measurement target sits is employed. Note that the processing unit 120 in advance stores the flight number identifier.

The communication unit 140 is configured with a communication apparatus that connects the biological information acquisition apparatus 10 with the network NT1 by using radio communication such as Wi-Fi®, for example. The communication unit 140 transmits the saved biological data stored in the storage unit 130 to the stress learning apparatus 20 via the network NT1 under control of the processing unit 120. Here, the communication unit 140 may transmit the saved biological data to the stress learning apparatus 20 under control of the processing unit 120 when the airplane X arrives at a destination. However, this is one example, and the communication unit 140 may transmit the saved biological data to the stress learning apparatus 20 at each time when the saved biological data are generated, that is, each time when the biological sensor 110 measures the biological data.

Further, the communication unit 140 acquires the biological data measured by the biological sensor 110 via a wireless LAN or a wired LAN, which is provided in the airplane X.

The stress learning apparatus 20 includes a history data management unit 210, an accumulation unit 220, a preference data generation unit 230, and a communication unit 240. In FIG. 2, the history data management unit 210 and the preference data generation unit 230 are configured with CPUs, for example. Further, the accumulation unit 220 is configured with a non-volatile storage apparatus, for example. The communication unit 240 is configured with a communication apparatus that connects the stress learning apparatus 20 with the networks NT1 and NT2, for example.

The history data management unit 210 generates biological history data by associating the saved biological data transmitted from the biological information acquisition apparatus 10 with a customer identifier and stores the biological history data in the accumulation unit 220. Here, in a case where the saved biological data are transmitted from the biological information acquisition apparatus 10, the history data management unit 210 transmits an inquiry signal for inquiring the customer identifier that corresponds to the seat identifier and the flight number identifier, which are included in the transmitted saved biological data, to the reservation management apparatus 30 and may thereby acquire the customer identifier.

The accumulation unit 220 stores a biological history table T3 in which the biological history data are registered. FIG. 5 is a diagram that illustrates one example of a data configuration of the biological history table T3. The biological history table T3 is a database in which one piece of biological history data is registered in one record and includes fields of “customer identifier”, “flight number identifier”, “seat identifier”, and “biological data”. “Customer identifier” is information that identifies the customer and employs a symbol string that is uniquely allocated to each of the customers. “Flight number identifier” and “seat identifier” are the same as FIG. 3. In the field of “biological data”, the biological data of each of the customers are registered.

In the example of FIG. 5, biological data VT1 and biological data VT2 of the respective seat identifier “line 3 A” and seat identifier “line 3 E” for the customer 102 of the customer identifier “U03” are registered. In the example of FIG. 5, an example is illustrated where the biological data about the customer 102 of the customer identifier “U03” are registered in the biological history table T3. However, this is one example. Actually, the biological data about all the customers 102 to be management targets with respect to each airplane flight that the customers 102 board, that is, with respect to each of the seats are registered in the biological history table T3.

In such a manner, because the biological data for each of the seats on which the customers sit are registered in the biological history table T3, the preference data generation unit 230 that will be described later may generate preference data that indicate the preference of the customer for the seat.

FIG. 2 will be referred to again. The preference data generation unit 230 generates the preference data that indicate the preference of each of the customers 102 for the seat 101 by using the biological history data registered in the biological history table T3. Here, the preference data are data in which a position attribute to which the seat on which the customer 102 sits on board is associated with a stress indicator.

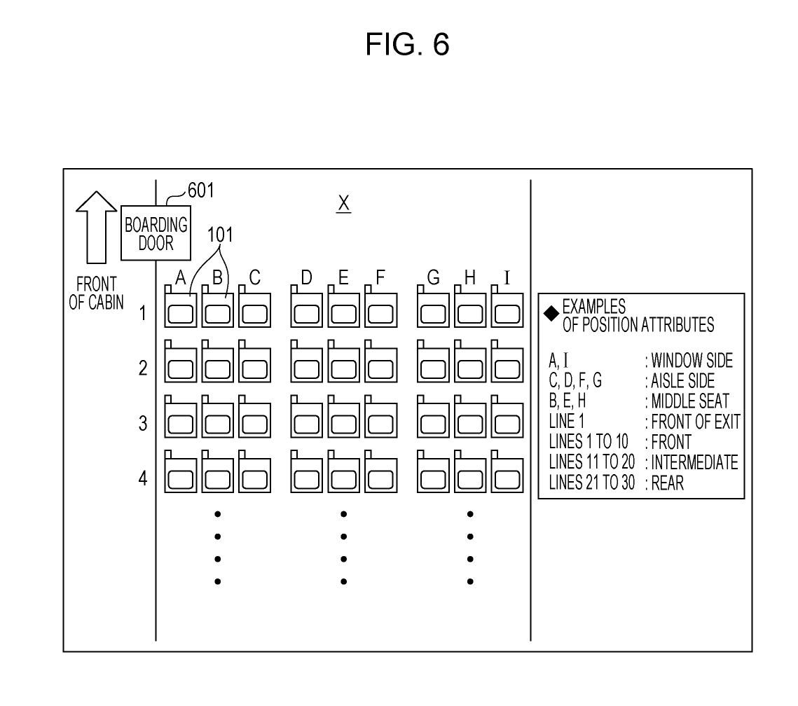

FIG. 6 is a diagram that illustrates one example of a seat arrangement diagram which illustrates arrangement of the seats 101 in the cabin of the airplane X. The arrow in this seat arrangement diagram points towards the front of the cabin. Further, in this seat arrangement diagram, the seat identifier is given to each of the seats 101 by a pair of a value that indicates the order in a line in the transverse direction and a symbol that indicates the order in a line in the longitudinal direction. Values such as “1”, “2”, and “3” are assigned to the lines in the transverse direction in the order from the front, and symbols such as “A”, “B”, and “C” are assigned to the lines in the longitudinal direction from the left to the right. In this example, because nine lines of seats 101 in the longitudinal direction are provided, nine symbols of “A” to “I” are assigned to the lines in the longitudinal direction. Accordingly, the seat 101 that is positioned in the upper left apex has the seat identifier “1A”, and the seat 101 that is in the next position on the right has the seat identifier “1B”. Note that FIG. 6, in all the transverse lines, the nine lines of seats 101 in the longitudinal direction are provided. However, this is one example, and 10 or more or 8 or less lines of seats 101 may be provided. A boarding door 601 that communicates with the outside of the airplane X is provided in front of the seat of the seat identifier “1A”.

In this embodiment, the position attribute includes a first position attribute that indicates plural regions obtained by dividing the cabin in the longitudinal direction, a second position attribute that indicates plural regions obtained by dividing the cabin in the transverse direction, and a third position attribute that is a seat region around the boarding door 601. That is, in this embodiment, the seats 101 are divided in three views of the first to third position attributes.

In the example of FIG. 6, the first position attribute indicates three regions of “window side”, “aisle side”, and “middle seat”, which are obtained by diving the seats 101 in the cabin in the transverse direction, for example. In the example in FIG. 6, the seats 101 in two lines of “A” and “I” positioned along walls in the cabin have the first position attribute of “window side”. Further, the seats 101 in four lines of “C”, “D”, “F”, and “G” that face two aisles in the cabin have the first position attribute of “aisle side”. Further, the seats 101 in three lines of “B”, “E”, and “H” that do not face the walls or the aisles have the first position attribute of “middle seat”.

Some customers 102 prefer the window side where the customers 102 may see outside scenery, and some customers 102 prefer the aisle side where movement in the cabin is easy. In this embodiment, in order to take into consideration the preferences of such customers 102, the first position attribute is configured with “window side”, “middle seat”, and “aisle side”.

However, this is one example, and the first position attribute may be configured with at least two of “window side”, “aisle side”, and “middle seat”. Further, the first position attribute may indicate regions that are obtained by dividing the seats 101 in the transverse direction in another view than “window side”, “aisle side”, and “middle seat”. For example, the first position attribute may be configured with a region that includes three lines of “A”, “B”, and “C”, a region that includes three lines of “D”, “E”, and “F”, and a region that includes three lines of “G”, “H”, and “I”, which are a region formed of a group of seats interposed between the two aisles and regions formed of groups of seats interposed between the aisle and the wall. Further, the first position attribute may be configured with four or more regions.

In the example of FIG. 6, the second position attribute indicates three regions of “front”, “intermediate”, and “rear”, which are obtained by diving the seats 101 in the cabin in the longitudinal direction, for example. In the example in FIG. 6, the seats 101 that are included in the lines “1” to “10” in the transverse direction positioned in a front portion in the cabin have the second position attribute of “front”. Further, the seats 101 that are included in the lines “11” to “20” in the transverse direction positioned in an intermediate portion in the cabin have the second position attribute of “intermediate”. Further, the seats 101 that are included in the lines “21” to “30” in the transverse direction positioned in a rear portion in the cabin have the second position attribute of “rear”. Some customers 102 prefer the front portion in the cabin, and some customers 102 prefer the rear portion. In this embodiment, in order to take into consideration the preference of such customers among the customers 102, the second position attribute is configured with “front”, “intermediate”, and “rear”.

However, this is one example, and the second position attribute may be configured with at least two of “front”, “intermediate”, and “rear”. Further, the second position attribute may indicate regions that are obtained by dividing the seats 101 in the longitudinal direction in another view than “front”, “intermediate”, and “rear”. For example, in a large passenger plane, the second position attribute may be configured with four or more regions, which are “intermediate 1”, “intermediate 2”, and “intermediate 3” in addition to “front” and “rear”.

The third position attribute is an attribute that indicates a region around the boarding door 601. In the example of FIG. 6, the seats 101 in the line “1” in the transverse direction that are close to the boarding door 601, that is, the seats 101 in the foremost line have the third position attribute. Note that in the example of FIG. 6, the third position attribute is set as the seats 101 in the foremost line. However, this is one example. For example, in a case where plural boarding doors 601 are present, the seats 101 in one line in the transverse direction in immediate rear of each of the plural boarding doors 601 may have the third position attribute. The seats 101 in one line in the transverse direction in immediate rear of the boarding door 601 have large front spaces compared to the seats 101 in the other lines in the transverse direction. Thus, some customers 102 prefer the seats 101 in one line in the transverse direction in immediate rear of the boarding door 601. Thus, in this embodiment, in order to take into consideration the preference of such customers, the third position attribute is provided.

Note that the preference data generation unit 230 in advance stores the seat arrangement diagram of each of the airplanes to be management targets and may specify the position attribute to which the seat belongs by using the seat arrangement diagram.

FIG. 2 will be referred to again. With respect to one certain customer 102, the preference data generation unit 230 calculates the stress values from the biological data stored in the respective records of the biological history table T3, totals the calculated stress values with respect to each of the first to third position attributes, and may thereby generate the preference data of the certain customer 102. Then, the preference data generation unit 230 may generate the preference data for each of all the customers 102 to be management targets.

In this embodiment, the millimeter-wave radar is employed as the biological sensor 110. Accordingly, the preference data generation unit 230 estimates the heartbeat intervals from the biological data measured by the biological sensor 110, performs the frequency analysis of the fluctuation of the heartbeat intervals, which is disclosed in above-described Japanese Patent No. 5257525, for the estimated heartbeat intervals, and may thereby calculate the stress value of the customer 102. Specifically, the preference data generation unit 230 performs the frequency analysis of the estimated heartbeat intervals, thereby detects a level HF of a high-frequency peak that occurs around a frequency of 0.3 Hz and a level LF of a low-frequency peak that occurs around 0.1 Hz, and may thereby calculate LF/HF as the stress value. Note that because the value of LF/HF increases as the stress becomes higher, the higher value of the stress value indicates the higher stress.

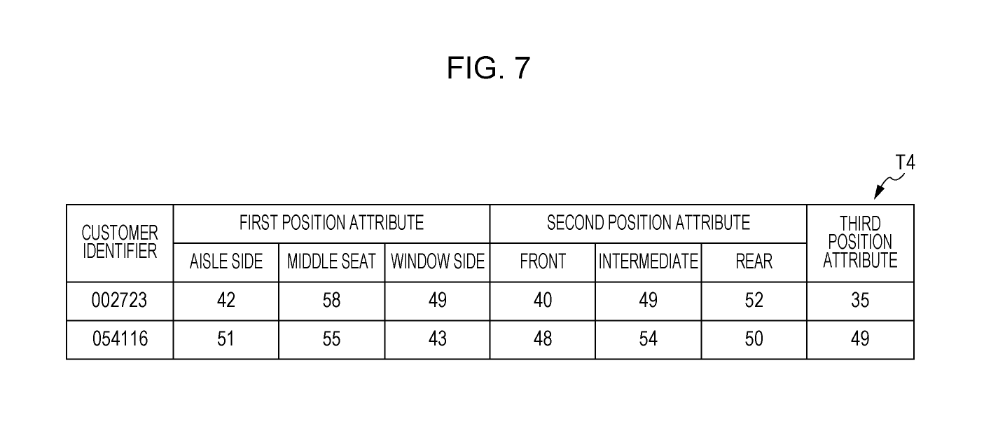

Further, the preference data generation unit 230 uses the stress values written in respective cells of a preference data table T4, which will be described later (see FIG. 7), and newly calculated stress values, thereby calculates the deviation values of the stress values of the respective cells (hereinafter referred to as “stress deviation value”), and writes the stress deviation values in the respective cells in addition to the stress values.

FIG. 7 is a diagram that illustrates one example of a data configuration of the preference data table T4 in which the preference data are registered. In the preference data table T4, the preference data of one customer 102 are registered in one record. The preference data table T4 includes fields of “customer identifier”, “first position attribute”, “second position attribute”, and “third position attribute”. The field of “first position attribute” further includes fields of “aisle side”, “middle seat”, and “window side”. The field of “second position attribute” further includes fields of “front”, “intermediate”, and “rear”. Further, in the preference data table T4, the respective stress values of the customers 102 in accordance with three first position attributes, three second position attributes, and one third position attribute are registered. Note that in FIG. 7, the value registered in each of the cells indicates the stress deviation value, and the stress value is not illustrated. Further, the stress value and the stress deviation value are examples of the stress indicator. Further, in FIG. 7, the stress indicator registered in each of the cells of the first position attribute is one example of first preference data, the stress indicator registered in each of the cells of the second position attribute is one example of second preference data, and the stress indicator registered in each of the cells of the third position attribute is one example of third preference data.

In the example of FIG. 7, the preference data of two customers 102 of the customer identifiers “002723” and “054116” are registered. However, this is one example. Actually, the preference data of all the customers 102 to be management targets are registered.

In a case where the preference data generation unit 230 calculates one stress value from one certain piece of biological data, the preference data generation unit 230 decides the first position attribute and second position attribute, to which the stress value belongs, from the seat identifier that is associated with the certain piece of biological data, and writes the stress value in the cells that correspond to the decided first position attribute and second position attribute. Further, the preference data generation unit 230 decides whether the stress value belongs to the third position attribute from the seat identifier that corresponds to the calculated stress value and writes the calculated stress value in the concerned cell of the third position attribute in a case where the calculated stress value belongs to the third position attribute.

For example, in a case where the stress value for the seat identifier “1A” is calculated with respect to the customer 102 of the customer identifier “002723”, the seat identifier “1A” corresponds to the first position attribute of “window side” and the second position attribute of “front”. Thus, the stress value is written in each of “window side” and “front” of the concerned customer identifier.

Here, in a case where the stress value is already written in the corresponding cell, the preference data generation unit 230 may calculate the average value, for example, of the written stress value and the newly calculated stress value and may thereby update the stress value of the corresponding cell by the calculated average value. Further, when the update of the stress value is finished, the preference data generation unit 230 may calculate the stress deviation value of each of the cells from the stress value of each of the cells and may write the stress deviation value in each of the cells.

FIG. 2 will be referred to again. The communication unit 240 transmits the preference data generated by the preference data generation unit 230 to the reservation management apparatus 30 via the network NT2.

The reservation management apparatus 30 includes a processing unit 310, a reservation information storage unit 320, a preference data storage unit 330, a priority calculation unit 340, a presentation processing unit 350, and a communication unit 360. In FIG. 2, the processing unit 310, the priority calculation unit 340, and the presentation processing unit 350 are configured with CPUs, for example. The reservation information storage unit 320 and the preference data storage unit 330 are configured with non-volatile storage apparatuses, for example. The communication unit 360 is configured with a communication apparatus for connecting the reservation management apparatus 30 with the network NT2.

In a case where the communication unit 360 receives the preference data transmitted from the stress learning apparatus 20, the processing unit 310 causes the preference data storage unit 330 to store the received preference data. Further, the processing unit 310 manages a reservation information table T2 that is stored in the reservation information storage unit 320.

FIG. 4 is a diagram that illustrates one example of a data configuration of the reservation information table T2. The reservation information table T2 is a database in which one piece of reservation information is registered in one record and includes fields of “flight number identifier”, “seat identifier”, and “customer identifier”. The reservation information is information that indicates which seat of which airplane flight is reserved with respect to each of the customers 102.

“Flight number identifier” and “seat identifier” are the same as FIG. 3, and “customer identifier” is the same as FIG. 5. In FIG. 4, the reservation information is registered which indicates that the customer 102 of the customer identifier “U03” has reserved the seat of the seat identifier “line 3 A” for the airplane X of the flight number identifier “PAL485, Oct. 1, 2016, Kansai International Airport to Narita Airport”.

Note that in the example of FIG. 4, only one piece of reservation information is illustrated. However, actually, pieces of reservation information for plural seats of plural airplanes X to be management targets are registered.

In a case where the communication unit 360 receives the inquiry signal for inquiring the above-described customer identifier from the stress learning apparatus 20, the processing unit 310 acquires the customer identifier that corresponds to “seat identifier” and “flight number identifier” included in the inquiry signal from the reservation information table T2 that is in advance stored by the reservation information storage unit 320 and transmits the customer identifier to the stress learning apparatus 20 by using the communication unit 360.

FIG. 2 will be referred to again. The priority calculation unit 340 calculates the respective stress deviation values of the plural seat regions specified by the first to third position attributes based on the preference data stored in the preference data storage unit 330 and calculates the priorities of the plural seat regions in order from lowest to highest calculated stress deviation value.

Specifically, the priority calculation unit 340 calculates the respective stress deviation values of nine seat regions resulting from the mutual combinations of the three kinds of first position attributes and the three kinds of second position attributes and calculates the stress deviation value of the seat region that corresponds to the third position attribute.

FIG. 7 will be referred to. The first position attribute includes “aisle side”, “middle seat”, and “window side”, and the second position attribute includes “front”, “intermediate”, and “rear”. Thus, the priority calculation unit 340 calculates the stress deviation values for the nine seat regions specified by the groups of the first position attribute and the second position attribute, such as the seat region of (aisle side, front), the seat region of (aisle side, intermediate), . . . , the seat region of (window side, rear). The stress deviation values of those nine seat regions are calculated by adding the stress deviation values of the first position attribute and the stress deviation values of the second position attribute. For example, with respect to the customer 102 of the customer identifier “002723”, the stress deviation value of the seat region specified by the first position attribute of “aisle side” and the second position attribute of “front” is calculated such that “42”+“40”=“82”.

Further, the stress deviation value of the seat region that corresponds to the third position attribute is calculated by adding an offset value (for example, “45”) to the stress deviation value of the third position attribute. Note that because the third position attribute corresponds to the seat region one to one, the seat region that corresponds to the third position attribute is the region itself that is represented by the third position attribute.

Further, the priority calculation unit 340 ranks those 10 seat regions in ascending order of the stress deviation value.

The presentation processing unit 350 sequentially presents the seats to be the reservation candidates from the seat regions with the high priority (low stress deviation value). Specifically, the presentation processing unit 350 sequentially presents the seats to be the reservation candidates from the prescribed number (for example, five) of seat regions in order from highest to lowest priority.

For example, in the example of FIG. 7, the stress deviation values of the customer 102 of the customer identifier “002723” become smaller in order of the seat region that corresponds to the third position attribute the seat region of (aisle side, front) the seat region of (window side, front) the seat region of (aisle side, intermediate) the seat region of (aisle side, rear). Thus, the seats to be the reservation candidates are decided in this order.

Further, in the example of FIG. 7, the stress deviation values of the customer 102 of the customer identifier “054116” become smaller in order of the seat region of (window side, front) the seat region of (window side, rear) the seat region that corresponds to the third position attribute the seat region of (aisle side, intermediate) the seat region of (aisle side, rear). Thus, the seats to be the reservation candidates are decided in this order.

More specifically, the presentation processing unit 350 first extracts one or plural available seats of the concerned airplane flight as reservation candidate seats in the seat region with the first priority from the reservation information table T2. Then, the presentation processing unit 350 transmits candidate seat information that indicates the extracted reservation candidate seats to the reservation terminal 40 by using the communication unit 360 and causes the reservation terminal 40 to present the reservation candidate seats.

Then, in a case where the presentation processing unit 350 receives reservation instruction information that any seat of the presented reservation candidate seats is reserved from the reservation terminal 40, the presentation processing unit 350 causes the reservation information table T2 to reflect a fact that the seat indicated by the reservation instruction information is reserved by the concerned customer 102. Meanwhile, in a case where the presentation processing unit 350 receives the reservation instruction information that no seat among the reservation candidate seats is reserved from the reservation terminal 40, the presentation processing unit 350 extracts one or plural available seats of the concerned airplane flight as the reservation candidate seats in the seat region with the next higher priority and causes the reservation terminal 40 to present the extracted reservation candidate seat. Then, in a case where the customer 102 sends the reservation instruction information that the customer 102 reserves any seat of the presented reservation candidate seats from the reservation terminal 40, the presentation processing unit 350 causes the reservation information table T2 to reflect a fact that the concerned seat is reserved by the concerned customer 102.

In such a manner, the presentation processing unit 350 sequentially presents the reservation candidate seats from the five seat regions with the high priority until the seat reservation is settled. Then, in a case where the reservation is not settled for the fifth priority seat region, the presentation processing unit 350 may extract one or plural available seats from the sixth to tenth priority seat regions as the reservation candidate seats and may cause the reservation terminal 40 to present the reservation candidate seats.

The communication unit 360 receives various kinds of information (such as the preference data) transmitted from the stress learning apparatus 20 and transmits various kinds of information (such as candidate seat information) to the reservation terminal 40. Further, the communication unit 360 receives various kinds of information (such as the reservation instruction information) transmitted from the reservation terminal 40.

The reservation terminal 40 includes a processing unit 410, a display unit 420, an operation unit 430, and a communication unit 440. In FIG. 2, the processing unit 410 is configured with a CPU, for example. The display unit 420 is configured with a display apparatus such as a liquid crystal panel. The operation unit 430 is configured with input apparatuses such as a touch panel, a keyboard, and a mouse. The communication unit 440 is configured with a communication apparatus for connecting the reservation terminal 40 with the network NT2.

In a case where the operation unit 430 receives an operation by the customer 102 for an instruction for an access request to the reservation management apparatus 30, the processing unit 410 transmits the access request to the reservation management apparatus 30 by using the communication unit 440. Further, in a case where the above-described candidate seat information is transmitted from the stress learning apparatus 20, the processing unit 410 causes the display unit 420 to display a reservation candidate image that indicates the reservation candidate seat indicated by the candidate seat information. Further, in a case where the operation unit 430 receives an operation for an instruction for a reservation for any reservation candidate seat from the customer 102 who browses the reservation candidate image, the processing unit 410 transmits the reservation instruction information that indicates the seat of the instruction to the reservation management apparatus 30 by using the communication unit 440. Further, in a case where the operation unit 430 receives an operation indicating that no reservation for any reservation candidate seat is made from the customer 102 who browses the reservation candidate image, the processing unit 410 transmits the reservation instruction information that indicates the effect to the reservation management apparatus 30 by using the communication unit 440.

The display unit 420 displays various kinds of images (such as the reservation candidate image) under control of the processing unit 410. The operation unit 430 receives the operation from the customer 102. The communication unit 440 receives various kinds of information (such as the candidate seat information) from the reservation management apparatus 30 and transmits various kinds of information (such as the reservation instruction information) to the reservation management apparatus 30.

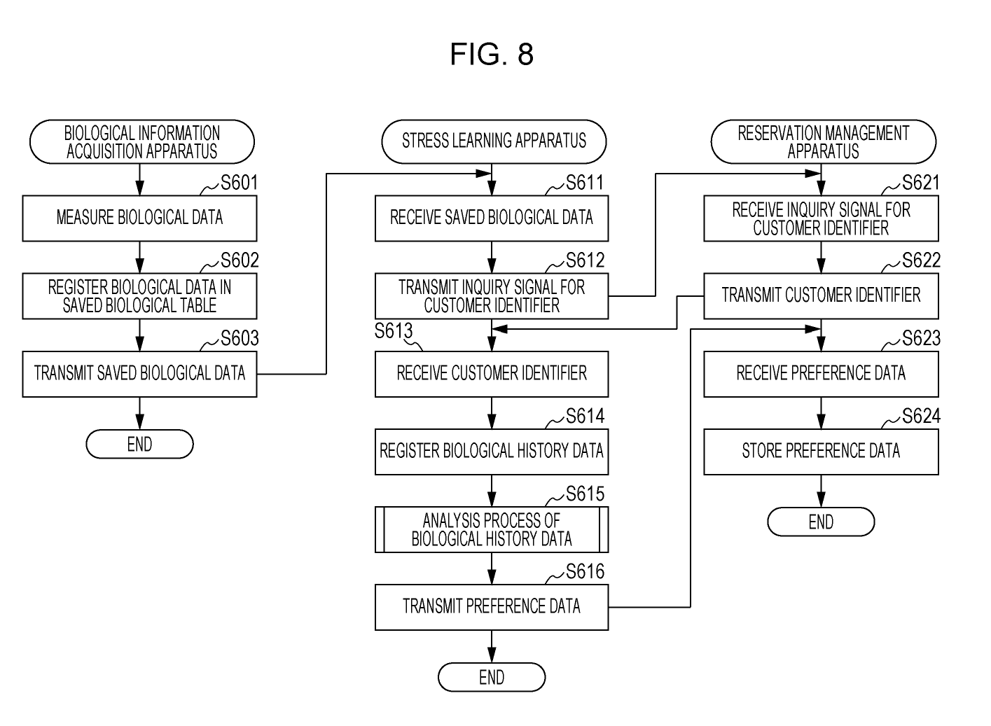

FIG. 8 is a flowchart that illustrates one example of a process from measurement of the biological data to generation of the preference data in the seat presentation system 1 according to the first embodiment of the present disclosure.

First, the biological sensor 110 measures the biological data. Here, the biological sensor 110 of the biological information acquisition apparatus 10 measures the biological data at prescribed sampling intervals (S601).

Next, the processing unit 120 of the biological information acquisition apparatus 10 registers the measured biological data in the saved biological table T1 (S602). Specifically, the processing unit 120 generates the saved biological data by associating the measured biological data with the seat identifier and with the flight number identifier and stores the saved biological data in the saved biological table T1.

Next, the communication unit 140 of the biological information acquisition apparatus 10 transmits all the saved biological data registered in the saved biological table T1 to the stress learning apparatus 20 when the airplane X arrives at a destination (S603). Note that in a case where the transmission of the saved biological data to the stress learning apparatus 20 finishes, the processing unit 120 may delete the saved biological data that are registered in the saved biological table T1. Further, in a case where a mode in which the saved biological data are transmitted to the stress learning apparatus 20 at each time when the saved biological data are generated is employed, the saved biological table T1 is not requested.

Next, the communication unit 240 of the stress learning apparatus 20 receives the saved biological data from the biological information acquisition apparatus 10 (S611). Next, the history data management unit 210 of the stress learning apparatus 20 transmits the inquiry signal for inquiring the customer identifier that corresponds to the flight number identifier and the seat identifier, which are included in the received saved biological data, to the reservation management apparatus 30 by using the communication unit 240 (S612). Here, in view of saving communication traffic, the history data management unit 210 may gather plural pieces of saved biological data that are included in one airplane flight and may thereby transmit those to the reservation management apparatus 30.

Next, the communication unit 360 of the reservation management apparatus 30 receives the inquiry signal (S621). Next, the processing unit 310 of the reservation management apparatus 30 acquires “customer identifier” that corresponds to “seat identifier” and “flight number identifier” included in the inquiry signal from the reservation information table T2 and transmits acquired “customer identifier” to the stress learning apparatus 20 by using the communication unit 360 (S622). For example, in a case where the inquiry signal that includes the flight number identifier “PAL485, Oct. 1, 2016, Kansai International Airport Narita Airport” and the seat identifier “line 3 A”, which are indicated in FIG. 3, is received, the processing unit 310 acquires the customer identifier “U03” from the reservation information table T2 illustrated in FIG. 4 and transmits the customer identifier “U03” to the stress learning apparatus 20. Note that the processing unit 310 may gather plural customer identifiers included in one airplane flight and may thereby transmit those to the stress learning apparatus 20.

Next, the communication unit 240 of the stress learning apparatus 20 receives the customer identifier transmitted from the reservation management apparatus 30 (S613).

Next, the history data management unit 210 of the stress learning apparatus 20 generates the biological history data by associating the customer identifier received in S613 with the corresponding saved biological data and registers the biological history data in the biological history table T3 (S614). For example, it is assumed that the customer identifier “U03” is received in accordance with the inquiry signal for the saved biological data that are stored in the record of the first row of the saved biological table T1 illustrated in FIG. 3. In this case, as indicated in the record of the first row of the biological history table T3 of FIG. 5, the history data management unit 210 generates the biological history data by associating the flight number identifier “PAL485”, the seat identifier “line 3 A”, and the biological data “VT1” with the customer identifier “U03” and registers the biological history data in the biological history table T3. As a result, the biological data of each of the customer 102 in accordance with the individual seats 101 are accumulated.

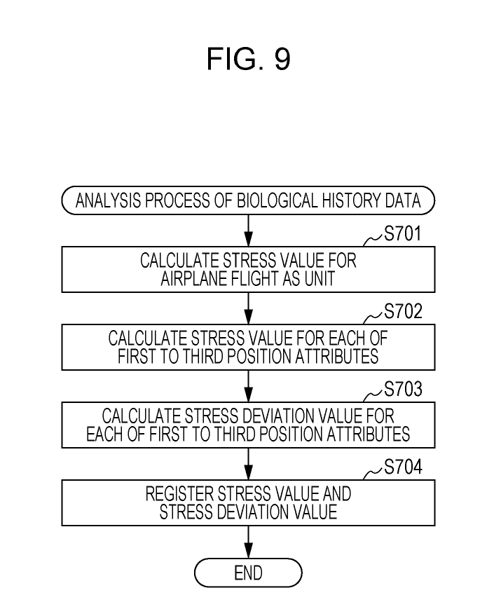

Next, the preference data generation unit 230 of the stress learning apparatus 20 executes an analysis process of the biological history data (S615). Note that details of the analysis process of the biological history data will be described later with reference to FIG. 9.

Next, the communication unit 240 of the stress learning apparatus 20 transmits the preference data that are generated by the analysis process of the biological history data to the reservation management apparatus 30 (S616).

Next, the communication unit 360 of the reservation management apparatus 30 receives the preference data (S623). Next, the processing unit 310 of the reservation management apparatus 30 causes the preference data storage unit 330 to store the received preference data (S624).

FIG. 9 is a flowchart that illustrates details of the analysis process of the biological history data which is indicated by S615 in FIG. 8.

First, the preference data generation unit 230 refers to the biological history table T3, reads out the biological data of one certain customer 102 to be a process target with respect to each of the airplane flights, and calculates the stress value with respect to each of the airplane flights by using the biological data that are read out (S701).

In FIG. 5, in a case where the certain customer 102 as the process target is the customer of the customer identifier “U03”, two pieces of biological data of the customer 102 of the customer identifier “U03” are registered in the biological history table T3. Thus, the two pieces of biological history data are read out, and two stress values are calculated. Accordingly, the stress value with respect to each of the airplane flights is calculated. Note that in a case where there is the biological history data for which the stress value is already calculated in the biological history table T3, the preference data generation unit 230 may not calculate the stress value for the biological history data.

Next, the preference data generation unit 230 decides the first to third position attributes to which the stress value belongs from the seat identifier that corresponds to the stress value calculated in S701 and calculates the stress value for each of the decided first to third position attributes (S702). In this case, in a case where there are the respective stress values for the first to third position attributes that are already calculated, the preference data generation unit 230 may calculate the respective averages between the newly calculated stress values for the first to third position attributes and the already calculated stress values for the first to third position attributes and may thereby calculate the respective stress values for the first to third position attributes. Next, the preference data generation unit 230 uses the respective stress values for the first to third position attributes of the other customers 102 and the respective stress values for the first to third position attributes of the certain customer 102 as the process target and thereby calculate the respective stress deviation values for the first to third position attributes of all the customers 102 (S703).

Next, the preference data generation unit 230 registers the respective stress values for the first to third position attributes of the certain customer 102 as the process target, which are calculated in S702, and the respective stress deviation values for the first to third position attributes of all the customers 102, which are calculated in S703, in the preference data table T4 (S704). As a result, the preference data table T4 illustrated in FIG. 7 is generated.

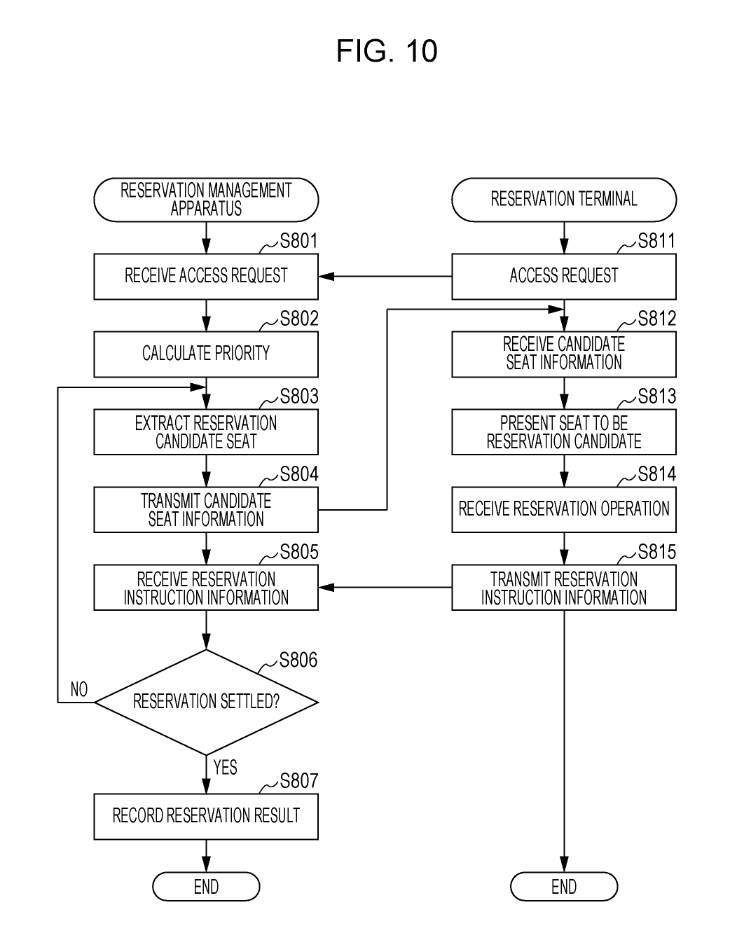

FIG. 10 is a flowchart that illustrates a process in a case where the reservation by the customer 102 is received in the seat presentation system 1 according to the first embodiment of the present disclosure.

First, in a case where the operation unit 430 receives an operation for an instruction for an access request from the customer 102, the communication unit 440 of the reservation terminal 40 transmits the access request to the reservation management apparatus 30 (S811).

Next, the communication unit 360 of the reservation management apparatus 30 receives the access request (S801). Next, the priority calculation unit 340 of the reservation management apparatus 30 reads out the preference data of the customer 102 who performs the access request from the preference data table T4 and calculates the priority of each of the seat regions by using the preference data that are read out (S802). Here, as described above, the respective stress deviation values of the nine seat regions that are specified by the first position attribute and the second position attribute and one seat region that is specified by the third position attribute are calculated, and the seat regions are ranked in order from lowest to highest stress deviation value.

Next, the presentation processing unit 350 of the reservation management apparatus 30 extracts one or plural seats to be the reservation candidates from the seat regions with the high priority (S803). Next, the presentation processing unit 350 transmits the candidate seat information that indicates the extracted reservation candidate seats to the reservation terminal 40 by using the communication unit 360 (S804).

Next, the communication unit 440 of the reservation terminal 40 receives the candidate seat information (S812). Next, the processing unit 410 of the reservation terminal 40 causes the display unit 420 to display the reservation candidate image that indicates the reservation candidate seat indicated by the candidate seat information and thereby presents the seats to be the reservation candidate to the customer 102 (S813).

Next, the operation unit 430 of the reservation terminal 40 receives a reservation operation about whether the reservation is made or the reservation is not made from the customer 102 who browses the reservation candidate image (S814).

Next, the communication unit 440 of the reservation terminal 40 transmits the reservation instruction information that indicates that a certain seat input by the reservation operation is reserved or that no reservation for any seat is made to the reservation management apparatus 30 (S815).

Next, the communication unit 360 of the reservation management apparatus 30 receives the reservation instruction information (S805). Next, in a case where the reservation instruction information that indicates that any seat is reserved is received in S805, the presentation processing unit 350 of the reservation management apparatus 30 assesses that the reservation is settled (YES in S806) and registers a reservation result in the reservation information table T2 (FIG. 4) (S807).

On the other hand, in a case where the reservation instruction information that indicates that no reservation for any seat is made is received in S805, the presentation processing unit 350 assesses that the reservation is not settled (NO in S806) and returns the process to S803. In this case, the presentation processing unit 350 of the reservation management apparatus 30 extracts the reservation candidate seat from the next higher priority seat regions (S803) and performs processes of S804 to S806. Then, in a case where the reservation operation of making a reservation is not input from the customer 102 even for the reservation candidate seat that is extracted from the seat region with the fifth priority, the presentation processing unit 350 presents one or plural available seats in the remaining seat regions as the reservation candidate seats to the customer 102 and may thereby settle the seat reservation. Alternatively, the presentation processing unit 350 may arbitrarily decide one seat from one or plural available seats in the remaining seat regions and may thereby settle the seat reservation.

In such a manner, in the seat presentation system 1 according to this embodiment, the biological history data in which the first biological data of the customer 102 who has boarded the airplane X, the seat identifier which indicates the seat 101 on which the customer 102 sits on board, and the customer identifier which identifies the customer 102 are associated with each other are accumulated. Further, the respective stress indicators of the customer 102 for the first to third position attributes to which the seats 101 on which the customer 102 sits on board belong are calculated from the accumulated biological history data, and the preference data are generated which indicate the preference of the customer in accordance with the seat regions that are specified by the first to third position attributes. Accordingly, the seat 101 that is preferred by the customer may be learned from the biological history data. Further, the plural seat regions are ranked such that the seat regions in which the customer 102 is more comfortable have the higher priority based on the preference data, and the seat to be the reservation candidate is sequentially presented to the customer 102 from the seat 101 included in the seat region with the higher priority. Thus, the seat 101 preferred by the customer 102 may be presented as the reservation candidate, and a smooth seat reservation may be realized.

### Second Embodiment

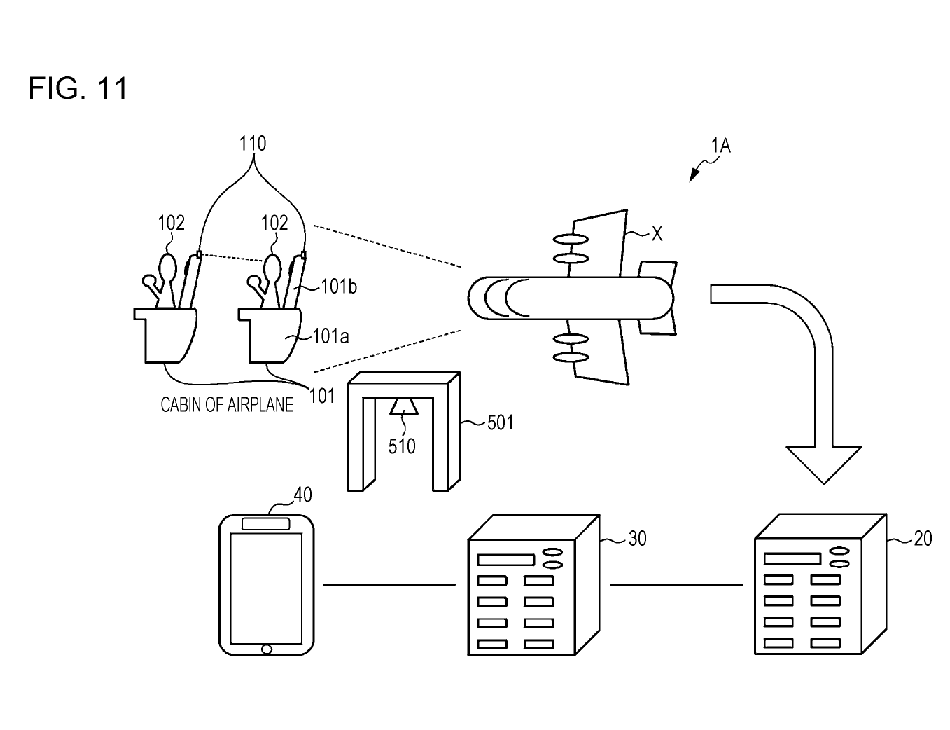

FIG. 11 is a diagram that illustrates one example of a general configuration of a seat presentation system 1A according to a second embodiment of the present disclosure. In addition to the measurement of the biological data in the airplane X, the seat presentation system 1A has a characteristic that the biological data are measured by using a biological sensor 510 (one example of a second biological sensor) that is provided to a boarding gate 501 in an airport and the stress indicator is calculated by using both pieces of the biological data. Note that in the second embodiment, the same reference characters will be given to the same configuration elements as the first embodiment, and a description will not be made.

The boarding gate 501 is a gate through which the customer 102 passes immediately before boarding the airplane X.

The biological sensor 510 is used for measuring the stress of the customer 102 in a state where the customer 102 does not board the airplane X. In a case where the customer 102 boards the airplane X of a domestic line in the airport, for example, it is typical to follow the procedures in which the customer 102 first performs boarding procedures at a check-in counter, next leaves a large baggage at a baggage counter, next goes through a security check at an inspection area, and finally passes through the boarding gate. It is sufficient that the biological sensor 510 may measure the biological data of the customer 102 at a time before boarding the airplane X. Thus, the installation place of the biological sensor 510 is not limited to the boarding gate 501 but may be the check-in counter, the baggage counter, or the inspection area.

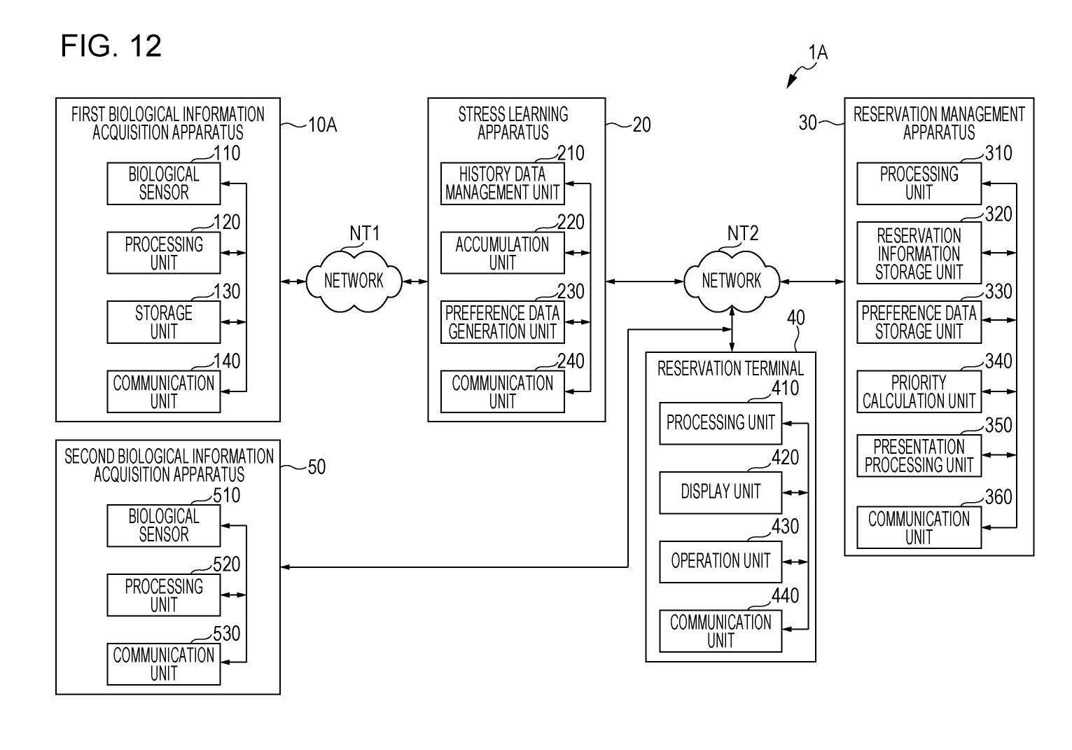

FIG. 12 is a block diagram that illustrates a configuration of the seat presentation system 1A according to the second embodiment of the present disclosure. The seat presentation system 1A is further provided with a second biological information acquisition apparatus 50 compared to the seat presentation system 1 illustrated in FIG. 2. Note that in the second embodiment, in order to distinguish the biological information acquisition apparatus 10 of the first embodiment from the second biological information acquisition apparatus 50, the biological information acquisition apparatus 10 will be referred to as a first biological information acquisition apparatus 10A. Further, in the second embodiment, in order to distinguish the biological data that are measured by the biological sensor 510 from the biological data that are measured by the biological sensor 110, the biological data measured by the biological sensor 510 will be referred to as second biological data, and the biological data measured by the biological sensor 110 will be referred to as the first biological data.

The second biological information acquisition apparatus 50 includes the biological sensor 510, a processing unit 520, and a communication unit 530. The biological sensor 510 employs the millimeter-wave radar, for example, similarly to the biological sensor 110.

The processing unit 520 is configured with a CPU, for example, and conducts general control of the second biological information acquisition apparatus 50. The processing unit 520 associates the second biological data measured by the biological sensor 510 with the seat identifier and with the flight number identifier and transmits the second biological data to the stress learning apparatus 20 via the network NT2. Note that the processing unit 520 reads seat information and the flight number of the airplane X, which are described on a ticket for the airplane X which is owned by the customer 102, by using a scanner (not illustrated), for example, and may thereby acquire the seat identifier and the flight number identifier.

The communication unit 530 is configured with a communication apparatus that connects the second biological information acquisition apparatus 50 with the network NT2 by using wireless communication such as Wi-Fi® or wired communication, for example. The communication unit 530 transmits the second biological data (hereinafter referred to as “second saved biological data”) that are associated with the seat identifier to the stress learning apparatus 20 under control of the processing unit 520. Note that in the second embodiment, the saved biological data that are generated by the first biological information acquisition apparatus 10A will be referred to as first saved biological data.

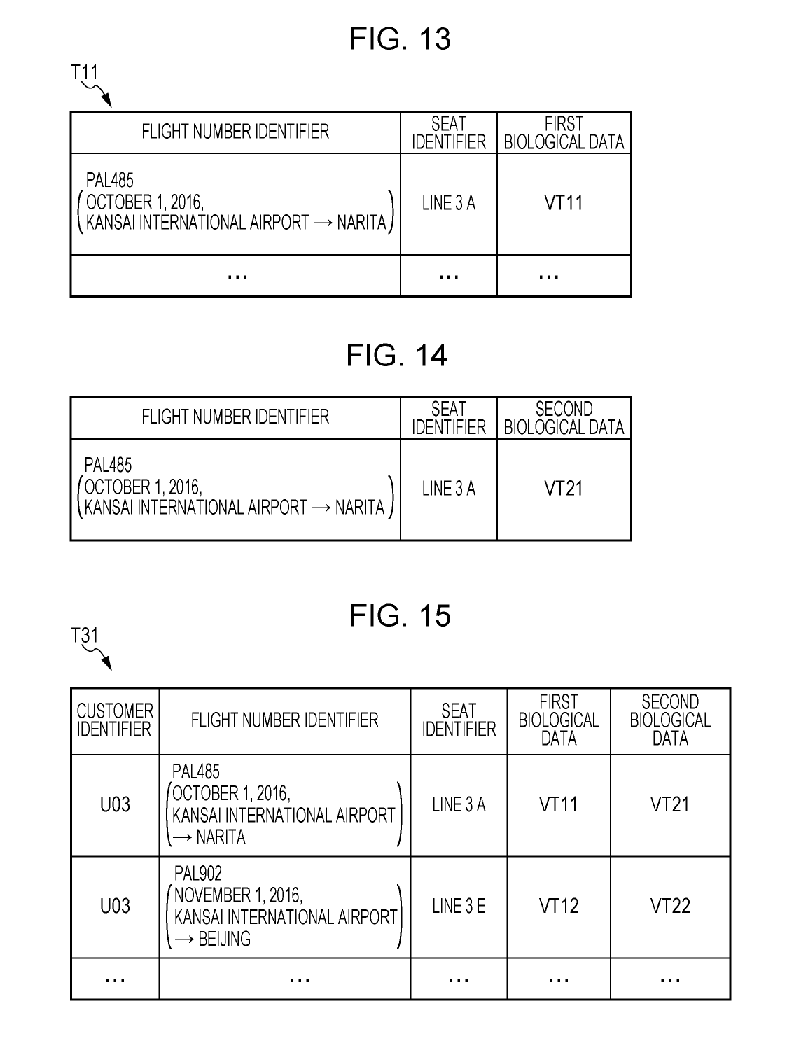

FIG. 13 is a diagram that illustrates one example of a data configuration of a first saved biological table T11 in which the first saved biological data are registered in the second embodiment of the present disclosure. In the first saved biological table T11, the difference from the saved biological table T1 illustrated in FIG. 3 is only a point that “biological data” becomes “first biological data”, and no fundamental difference is present.

FIG. 14 is a diagram that illustrates one example of a data configuration of the second saved biological data according to the second embodiment of the present disclosure. The second saved biological data include fields of “flight number identifier”, “seat identifier”, and “second biological data”. Note that in the second saved biological data, the difference from the first saved biological data illustrated in FIG. 13 is only a point that “first biological data” becomes “second biological data”, and no fundamental difference is present.

FIG. 12 will be referred to again. In the second embodiment, the history data management unit 210 generates the biological history data by associating the second biological data included in the second saved biological data and the customer identifier with the first saved biological data and accumulates the biological history data in the accumulation unit 220.

FIG. 15 is a diagram that illustrates one example of a data configuration of a biological history table T31 in which the biological history data are registered according to the second embodiment of the present disclosure. In the biological history table T31, the different point from the biological history table T3 illustrated in FIG. 5 is a point that a field of “second biological data” is further added.

The history data management unit 210 specifies the first saved biological data that have the same “customer identifier” and “flight number identifier” as “customer identifier” and “flight number identifier” in the second saved biological data, associates the second biological data included in the second saved biological data with the specified first saved biological data, and may thereby generate the biological history data.

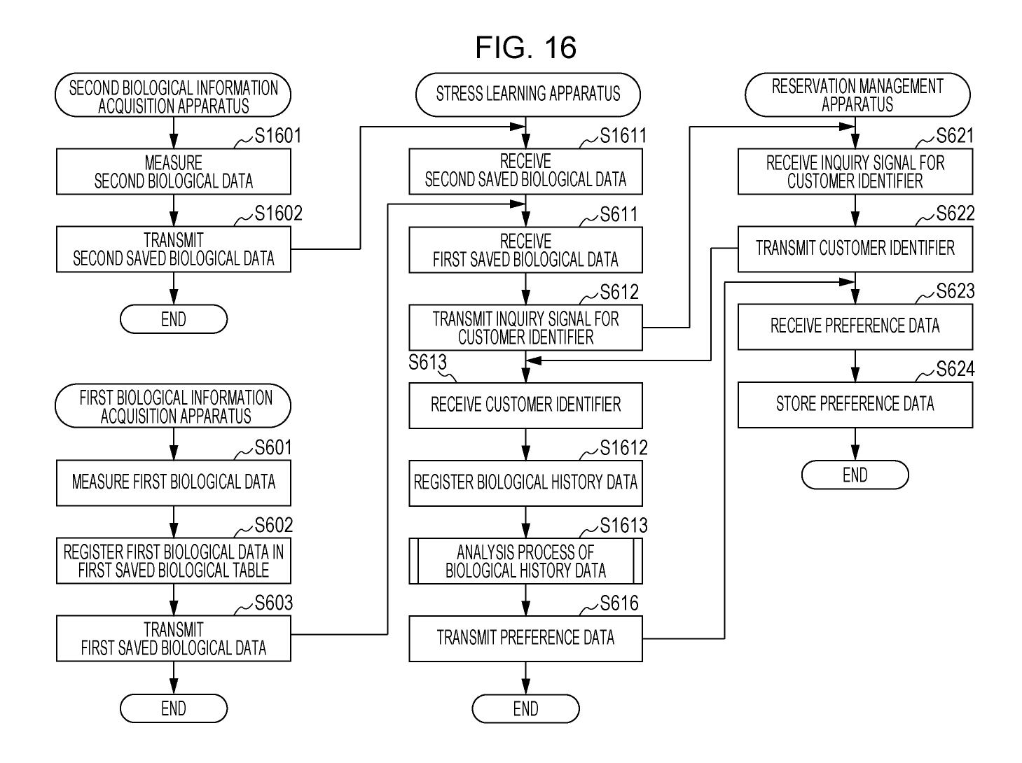

FIG. 16 is a flowchart that illustrates one example of a process from measurement of the first and second biological data to generation of the preference data in the seat presentation system 1A according to the second embodiment of the present disclosure. Note that in FIG. 16, the same reference characters are given to the same processes as FIG. 8, and a description will not be made.

First, the biological sensor 510 of the second biological information acquisition apparatus 50 measures the second biological data of the customer 102 who passes through the boarding gate 501 (S1601). Next, the processing unit 520 of the second biological information acquisition apparatus 50 generates the second saved biological data by associating the second biological data measured in S1601 with “flight number identifier” and “seat identifier” and transmits the second saved biological data to the stress learning apparatus 20 by using the communication unit 530 (S1602).

Next, the communication unit 240 of the stress learning apparatus 20 receives the second saved biological data (S1611). Then, processes of S611 to S613 are executed similarly to the first embodiment. Next, the history data management unit 210 of the stress learning apparatus 20 generates the biological history data by associating the second biological data included in the received second saved biological data with the corresponding first saved biological data and registers the biological history data in the biological history table T31 (S1612).

Next, the preference data generation unit 230 of the stress learning apparatus 20 executes an analysis process of the biological history data by using the biological history table T31 and generates the preference data (S1613).

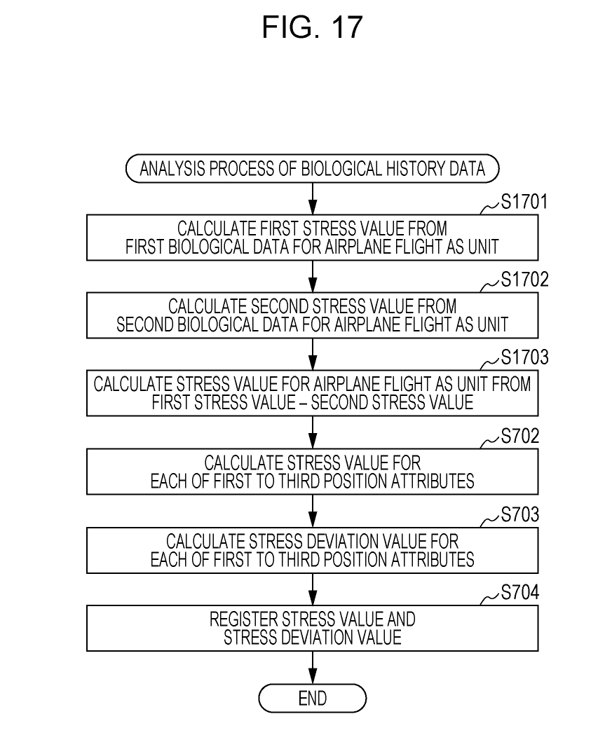

FIG. 17 is a flowchart that illustrates details of the analysis process of the biological history data which is indicated by S1613 in FIG. 16.

First, the preference data generation unit 230 refers to the biological history table T31, reads out the first biological data of one certain customer 102 to be a process target with respect to each of the airplane flights, and calculates a first stress value with respect to each of the airplane flights by using the first biological data that are read out (S1701).

Next, the preference data generation unit 230 refers to the biological history table T31, reads out the second biological data of one certain customer 102 to be a process target with respect to each of the airplane flights, and calculates a second stress value with respect to each of the airplane flights by using the second biological data that are read out (S1702).

Note that the first and second stress values are calculated by using the same scheme as the stress value described in the first embodiment.

Next, the preference data generation unit 230 calculates the stress value with respect to each of the airplane flights by subtracting the second stress value calculated in S1702 from the first stress value calculated in S1701 (S1703). An example of processes of S1701 to S1703 will be described by using the biological history data in the first row in FIG. 15. The preference data generation unit 230 calculates the first stress value from first biological data VT11, calculates the second stress value from second biological data VT21, and thereby calculates the stress value for the flight in the first row. The preference data generation unit 230 performs a similar process for the other biological history data and thereby calculates the stress value with respect to each of the airplane flights.

As the stress of the customer 102 on board the airplane X increases, the difference between the first stress value and the second stress value increases. Furthermore, because the stress value obtained from the difference is based on the stress value at a time before the customer 102 boards the airplane X as a reference, it may be considered that the stress value accurately reflects the influence of the stress that is given to the customer 102 by the airplane X. Accordingly, in this embodiment, the stress value of the customer 102 is calculated by using the stress value that is obtained by subtracting the second stress value from the first stress value.

Subsequently, the preference data generation unit 230 performs processes of S702 to S704 similarly to the first embodiment and thereby generates the preference data. In the second embodiment also, the preference data table T4 illustrated in FIG. 7 is generated similarly to the first embodiment.

In the seat presentation system 1A according to the second embodiment, the stress value is calculated based on the difference between the second stress value calculated from the second biological data at a time before the customer 102 boards the airplane X and the first stress value calculated from the first biological data of the customer 102 who has boarded the airplane X. Thus, the stress value of each of the customers may accurately be calculated.

### MODIFICATION EXAMPLE

(1) In the above embodiments, a description is made that the sensor which uses the millimeter-wave radar or the pressure sensing tube may be employed as the biological sensor 110. However, the present disclosure is not limited to this.

For example, Japanese Patent No. 5735592 discloses that the comfortableness of a user is evaluated by 10 levels of −5 to +5 from the biological data such as a heart rate, a pulse, and a body temperature. Accordingly, in the present disclosure, the comfortableness disclosed in Japanese Patent No. 5735592 may be employed as the stress indicator. In this case, the stress indicator may be calculated from a brain wave, a brain blood flow, a pulse wave, a blood pressure, a respiration rate, the body temperature, and a sweat rate.

Further, Japanese Unexamined Patent Application Publication No. 2012-249797 discloses that a value that results from a linear combination of the heart rate, the body temperature, the blood pressure, and the sweat rate is calculated as the stress value. Accordingly, in the present disclosure, the stress value disclosed in Japanese Unexamined Patent Application Publication No. 2012-249797 may be employed as the stress indicator.

Further, for example, Japanese Unexamined Patent Application Publication (Translation of PCT Application) No. 2003-534864 discloses a technique for assessing the stress to a person by using thermal image data of a face surface of the person. Accordingly, in the present disclosure, the stress indicator may be calculated by using the technique disclosed in Japanese Unexamined Patent Application Publication (Translation of PCT Application) No. 2003-534864.

(2) In the above embodiments, a description is made that the reservation terminal 40 is configured with the computer possessed by the customer 102. However, the present disclosure is not limited to this, but the reservation terminal 40 may be configured with a computer provided to the check-in counter. Alternatively, the reservation terminal 40 may be configured with a computer that is operated by an operator in order to arrange a trip of the customer 102 at a travel agency.

(3) In the above embodiments, the first to third position attributes are used. However, this is one example, and it is sufficient that at least one position attribute is used.

(4) In the above embodiments, the flight number identifier is used. However, because the preference data may be generated as long as the biological data of each of the seats may be recognized, the flight number identifier may be omitted.

The present disclosure enables a seat preferred by a customer to be presented as a reservation candidate seat and is thus useful for a reservation system for an airplane.

What is claimed is:

1. A seat presentation system, comprising:
an accumulator that accumulates biological history data in which first biological data of a customer, a seat identifier, and a customer identifier are associated with each other, the first biological data being measured while the customer is on board, the seat identifier indicating a seat of the customer on board, the customer identifier identifying the customer;
a preference data generator that generates, based on the biological history data of the customer, preference data in which a position attribute and a first stress indicator are associated with each other, the position attribute indicating an attribute of a position of the seat of the customer, the first stress indicator being calculated based on the first biological data;
a priority calculator that calculates a second stress indicator which corresponds to each of seat regions specified by the position attribute by using the preference data, and calculates priorities among the seat regions based on the second stress indicator; and
a presentation processor that presents seats to be reservation candidates sequentially from a seat which belongs to the seat region with higher priority.

2. The seat presentation system according to claim 1, further comprising a first biological sensor that measures the first biological data of the customer on board.

3. The seat presentation system according to claim 1, wherein
the position attribute includes a first position attribute and a second position attribute, the first position attribute indicating each of seat regions which are obtained by dividing a cabin of a transportation in a longitudinal direction, the second position attribute indicating each of seat regions which are obtained by dividing the cabin in a transverse direction,
the preference data generator generates, as the preference data, first preference data that correspond to the first position attribute and second preference data that correspond to the second position attribute, and
the priority calculator calculates the second stress indicator which corresponds to each of seat regions specified by a pair of the first position attribute and the second position attribute by using the first preference data and the second preference data, and calculates the priorities based on the second stress indicator.

4. The seat presentation system according to claim 3, wherein
the position attribute includes a third position attribute that indicates a seat region around a door of the transportation,
the preference data generator generates, as the preference data, third preference data that correspond to the third position attribute, and
the priority calculator calculates the second stress indicator which corresponds to each of the seat regions specified by a group of the first position attribute, the second position attribute, and the third position attribute by using the first preference data, the second preference data, and the third preference data, and calculates the priorities based on the second stress indicator.

5. The seat presentation system according to claim 2, further comprising:
a second biological sensor that measures second biological data of the customer at a time before boarding, wherein
the accumulator accumulates the second biological data of the customer associated with the first biological data of the customer as the biological history data, and
the preference data generator calculates the first stress indicator based on the first biological data and the second biological data.

6. The seat presentation system according to claim 1, wherein the presentation processor presents the seat to be the reservation candidate to a terminal apparatus that is possessed by the customer.

7. The seat presentation system according to claim 1, wherein the presentation processor presents the seat to be the reservation candidate to a terminal apparatus installed in a check-in counter.

8. The seat presentation system according to claim 1, wherein the preference data generator updates the preference data in a case where the accumulator accumulates the biological history data of the customer anew.

9. A seat presentation method, comprising:
measuring first biological data of the customer on board;
accumulating biological history data in which first biological data of a customer, a seat identifier, and a customer identifier are associated with each other, the first biological data being measured while the customer is on board, the seat identifier indicating a seat of the customer on board, the customer identifier identifying the customer;
generating, based on the biological history data of the customer, preference data in which a position attribute and a first stress indicator are associated with each other, the position attribute indicating an attribute of a position of the seat of the customer, the first stress indicator being calculated based on the first biological data;
calculating a second stress indicator which corresponds to each of seat regions specified by the position attribute by using the preference data, and calculates priorities among the seat regions based on the second stress indicator; and
presenting seats to be the reservation candidates sequentially from a seat which belongs to the seat region with the higher priority.
